(19) United States
(12) Patent Application Publication
(10) Pub. No.: US 2020/0400408 A1
(43) Pub. Date: Dec. 24, 2020

(54) CORNER-SAFE

(71) Applicant: Yoav Netzer, Moers (DE)

(72) Inventor: Yoav Netzer, Moers (DE)

(21) Appl. No.: 16/888,877

(22) Filed: Jun. 1, 2020

(30) Foreign Application Priority Data
May 30, 2019 (IL) 267015

(51) Int. Cl. F41G 3/16; F41G 1/46

(52) U.S. Cl. CPC F41G 3/165; G02B 27/0101; F41G 1/46

(57) ABSTRACT

A system for aiming a weapon, the system comprising: an imaging system configured to be mounted to a weapon and acquire targeting images of scenes along directions in which the weapon points; and a display system operable to display the acquired targeting images in directions suitable for convenient viewing by a user.

### RELATED APPLICATIONS

The present application claims the benefit under 35 U.S.C. § 119(a)-(d) of Israeli Application 267015 filed on May 30, 2019. The contents and disclosure of the prior application is incorporated herein by reference.

### FIELD

Example embodiments of the disclosure relate to providing a gunsight aiming aid

### BACKGROUND

Security personnel, whether police, soldiers, counter-terrorist commandos, or citizens engaged in protecting their home, neighborhood or country often find themselves in situations in which they cannot aim their weapons, measurement, signaling or imaging equipment from positions in which they have a direct line of sight with their targets or from positions of acceptable safety. Such situations typically arise in urban combat when it is advantageous to aim a weapon “around a corner”, and in combat that takes place in natural heterogenous terrain.

### SUMMARY

An aspect of an embodiment of the disclosure relates to providing a user operating a weapon with a system, hereinafter also referred to as a “Corner-Safe” system or simply “Corner-Safe”, for aiming the weapon that provides the user with a view of his or her target under circumstances in which the user cannot, or cannot safely, sight the weapon along the weapon's sights. In an embodiment, Corner-Safe comprises an imaging system configured to be mounted to the weapon and acquire images of scenes to which the weapon points, and a display system comprising a display screen that may be oriented for display of the acquired images in directions suitable for convenient viewing by the user.

The imaging system, hereinafter also referred to as a target imaging system, is configured to acquire an image of a scene along a direction in which a barrel and/or sights, hereinafter generically referred to as “sights”, of the weapon are aligned. Optionally, an optical axis of the target imaging system is substantially bore sighted with the weapon sights. In an embodiment, the display system is configured to receive the acquired image via wire and/or wireless communication with the target imaging system, automatically orient the display screen to a direction suitable for convenient viewing by the user, and display the acquired image on the display screen. Optionally, the display system comprises a camera, hereinafter also referred to as a screen camera, that acquires images, also referred to as screen camera images, of a scene along a direction in which the display screen faces and a processor for processing the screen camera images. In an embodiment the processor is configured to process the screen camera images to identify and determine a location of the face of the user. The display system may use the identified location to orient the display in a direction for convenient user viewing. In an embodiment the display screen is held by the user or mounted to the user's body and may for example be a screen of a mobile phone which is held or conveniently mounted to the user's body.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIGS. 1A-1C schematically show a side view of a Corner-Safe comprising a target imaging system and a display system mounted to an assault rifle in which a display screen of the display system is rotated about an axis to orient the screen in different directions for convenient viewing, in accordance with an embodiment of the disclosure;

FIGS. 2A-2C schematically show a top view of the Corner-Safe mounted to the assault rifle shown in FIGS. 1A-1C and rotated about another axis to orient the display screen in different convenient viewing directions;

FIG. 3 schematically shows the Corner-Safe shown in FIGS. 1A-2C being used to sight a target in an upper floor window of a building, in accordance with an embodiment of the disclosure;

FIG. 4 schematically shows a piezoelectric transmission system for rotating a display screen of a Corner-Safe, in accordance with an embodiment of the disclosure;

FIG. 5 schematically shows another piezoelectric transmission system for rotating a display screen of a Corner-Safe, in accordance with an embodiment of the disclosure;

FIG. 6 schematically shows a Corner-Safe in which a display screen of the Corner-Safe comprises a display screen of a mobile phone, in accordance with an embodiment of the disclosure;

FIG. 7 schematically shows a Corner-Safe comprising a telescopic sight and a display system comprising a rotatable mirror, in accordance with an embodiment of the disclosure; and

FIG. 8 schematically shows a Corner-Safe comprising a display control handle mounted on a handguard of an assault rifle in accordance with an embodiment of the disclosure.

### DETAILED DESCRIPTION

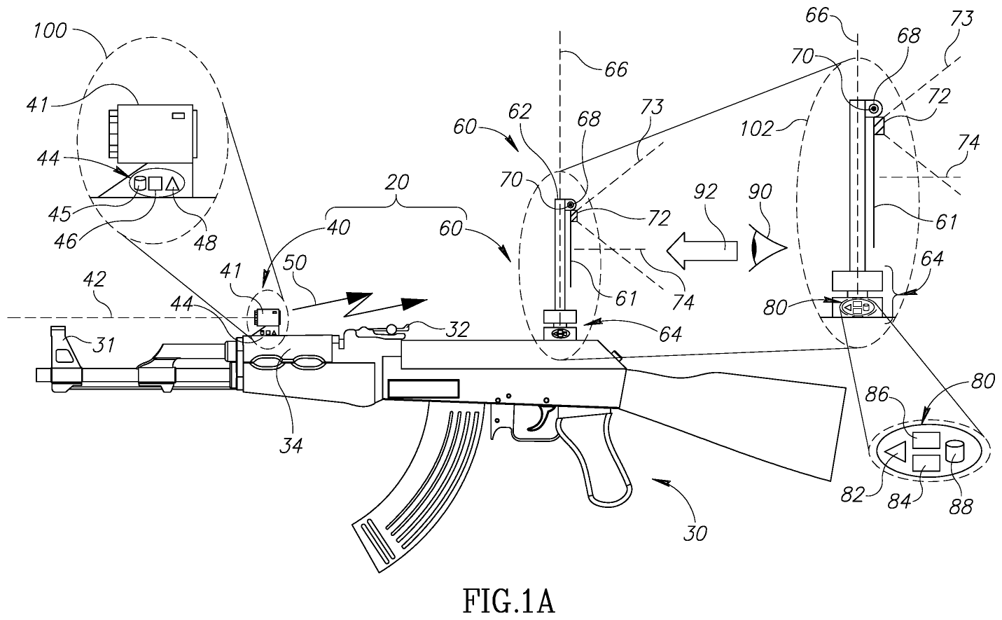

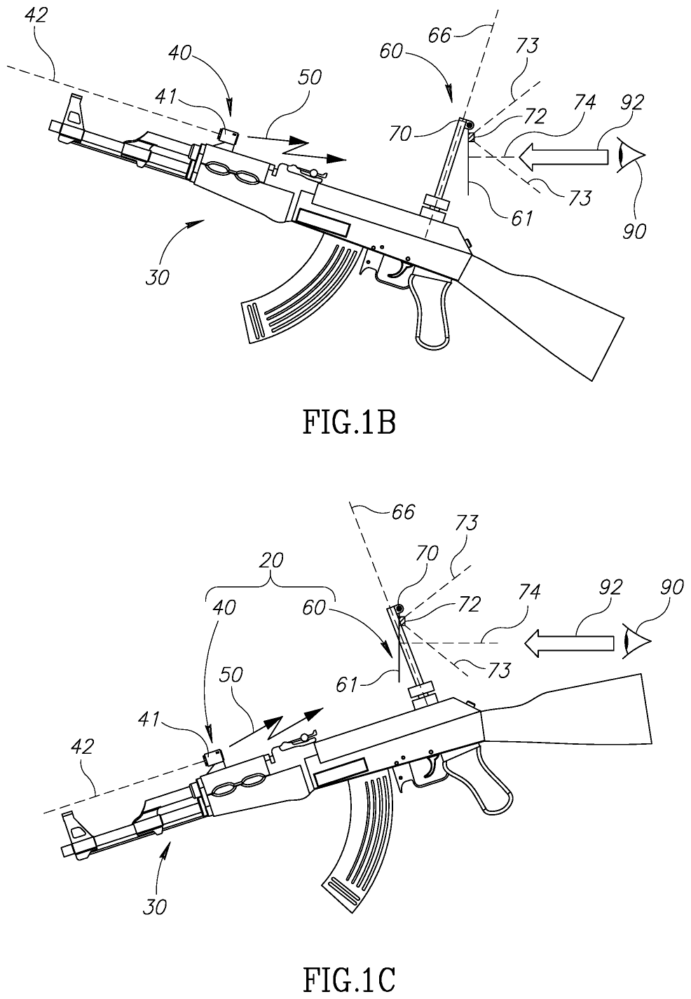

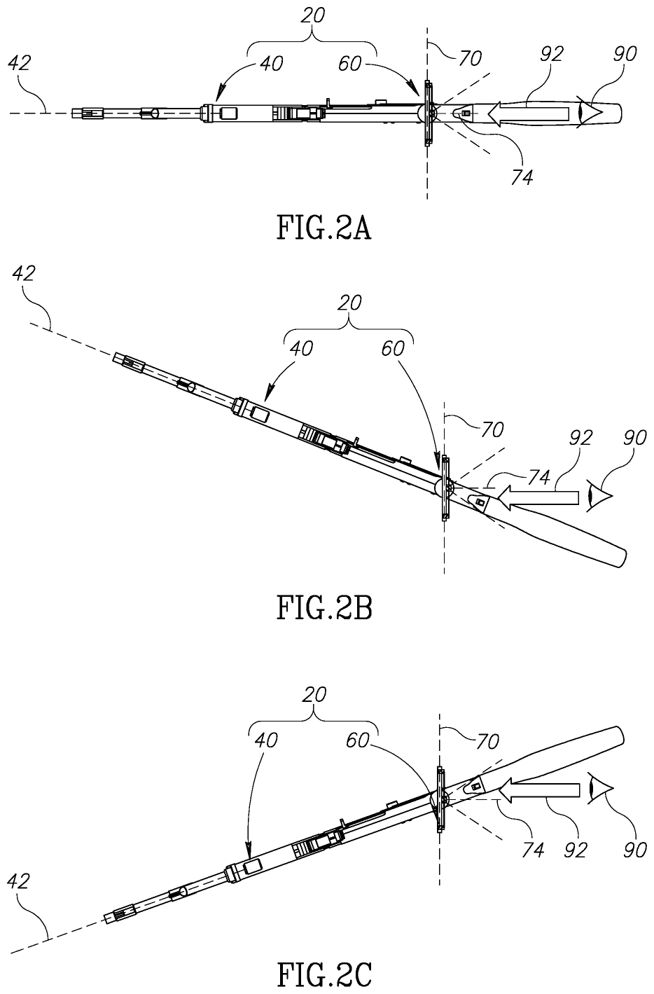

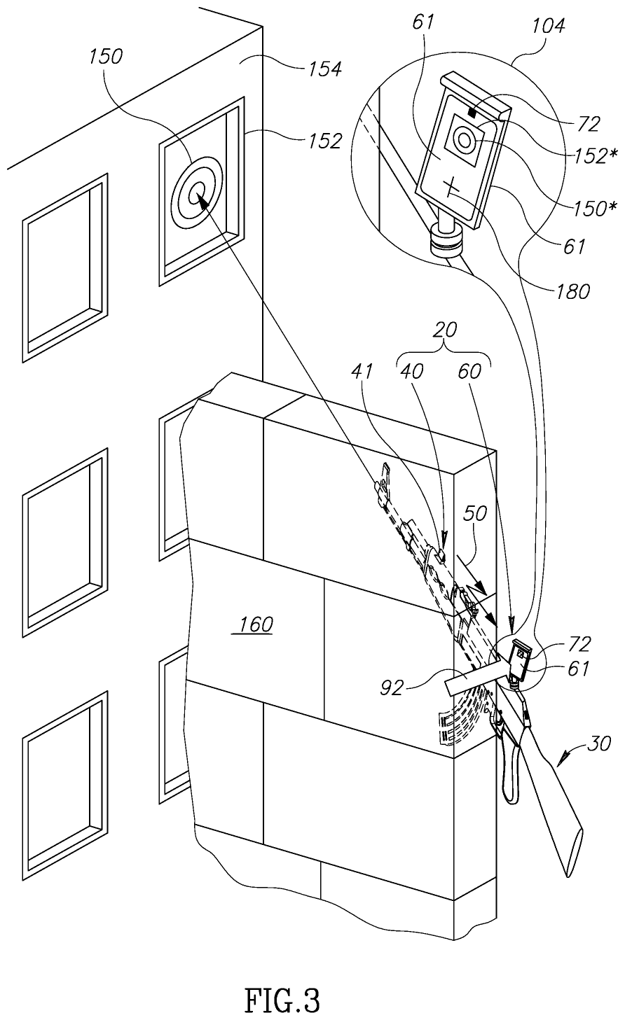

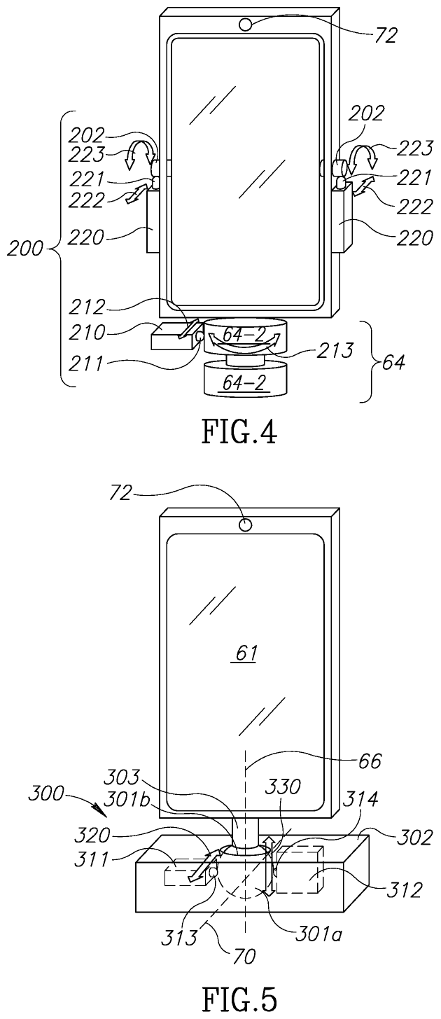

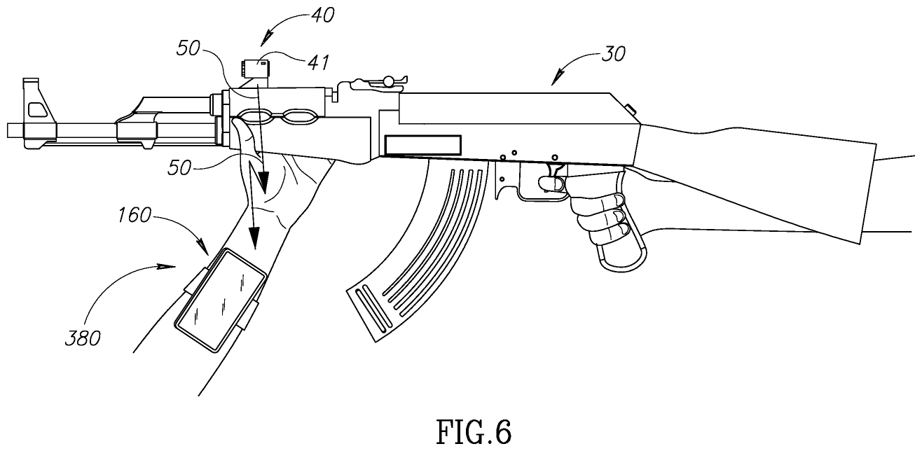

In the following description, features and operation of a Corner-Safe, optionally mounted to an assault rifle in accordance with an embodiment of the disclosure are discussed with reference to FIGS. 1A-3. FIG. 1A schematically shows an enlarged side view of the assault rifle and details of a Corner-Safe mounted to the assault rifle in accordance with an embodiment. The figure shows the assault rifle in a horizontal orientation and a gaze direction of a user using the assault rifle and viewing the Corner-Safe display screen. FIGS. 1B and 1C show side views of the assault rifle, display screen, and user gaze direction for the assault rifle rotated about a “horizontal” axis perpendicular to the planes of the side views to point the rifle respectively upwards and downwards relative to the position the assault rifle in FIG. 1A. FIGS. 2A-2C show top views of the assault rifle, display screen, and user gaze directions with the rifle rotated to different azimuthal angles about a “vertical” axis perpendicular to the planes of the top views. FIG. 3 illustrates the display screen oriented to assist a user attempting to aim the assault rifle at an elevated target from a position around a corner of a building from the target. Piezoelectric transmission systems that may be used to orient the display screen shown in FIGS. 1A-3 are discussed with reference to FIGS. 4 and 5. A Corner-Safe in accordance with an embodiment in which the display system is comprised in a user mobile phone is discussed with reference to FIG. 6.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

FIG. 1A schematically shows a side view of a Corner-Safe 20 mounted to an assault rifle 30 having front and rear sights 31 and 32, in accordance with an embodiment of the disclosure. Corner-Safe 20 comprises a target imaging system 40 and a display system 60 both of which, optionally, are mounted to the assault rifle.

Target imaging system 40 includes a camera 41, also referred to as a targeting camera 41, that is mounted optionally to a handguard 34 of the rifle and has an optical axis 42 boresighted with the assault rifle sights 31 and 32 so that the camera is operable to acquire images, hereinafter also referred to as “targeting images”, of a scene to which assault rifle 30 points. A center of a targeting image of a scene that camera 41 acquires images a portion of the scene that includes a region at which a line of sight aligned with sights 31 and 32 intercepts a feature of the scene. The target imaging system may include circuitry, represented by an ellipse 44, shown enlarged in an inset 100 optionally comprising a memory 45, processor 46, and a communications interface 48 operable to support composing and transmitting wireless and/or wire communications also referred to as transmissions, also referred to as “image transmissions”, encoded with a targeting image that camera 41 acquires. By way of example, communications interface 48 may be configured to transmit image transmission, represented by lighting arrows 50, in accordance with at least one or any combination of two or more of Ethernet, Bluetooth, and/or Wi-Fi transmission protocols, and/or a radio transmission protocol compatible with a mobile communications network.

Optionally, display system 60 shown enlarged in an inset 102 comprises a display screen 61 that has a normal 74 that extends substantially from a center of the display and is mounted to a support frame 62 seated on a “Lazy-Suzan” coupling 64. A user using assault rifle 30 is, represented by an eye icon 90 and a gaze direction of the user viewing display screen 61 is represented by a block arrow 92. Lazy-Suzan coupling 64 enables rotation of support frame 62 about an axis 66. Display screen 61 is optionally coupled to support frame 62 by a shaft or pins 68 so that it is rotatable about an axis 70, only an end of which is shown in the side view of FIG. 1. Display system 60 comprises circuitry represented by an ellipse 80 shown enlarged in an inset 102 comprising a communications interface 82 configured to receive image transmissions 50 from target imaging system 40, and a processor 84 for processing the image transmissions to display targeting images that the transmissions encode on display screen 61. In an embodiment circuitry 80 also includes an attitude controller 86 which is operable rotate display screen 61 about axes 66 and 70 to an orientation that is convenient for viewing by the user of assault rifle 30. Attitude controller 86 may control any of various motors and/or actuators, such as by way of example piezoelectric or stepper motors and/or actuators that are coupled to display screen 61 to control rotation of display screen 61. Examples of apparatus that may be used for controlling attitude of a display screen, such as display screen 61 of a Corner-Safe 20 in accordance with an embodiment are schematically shown in FIGS. 4 and 5 and discussed below with reference to the figures. Circuitry 80 may also comprise a memory 88 configured to store software comprising executable instructions and/or data that the processor may respectively execute and/or use to process and display targeting images received from target imaging system 40 and control attitude controller 86.

In an embodiment display system 60 comprises a facial recognition system operable to determine location of the face (not shown) of user 90 operating assault rifle 30. The facial recognition system may comprise a screen camera 72 configured to acquire images of scenes in a field of view (FOV) schematically represented by dashed lines 73 that includes a volume of space in front of display screen 61 in which the user's face is expected to be located when using assault rifle 30. Optionally screen camera 72 comprises a range camera operable to acquire range and contrast images of the scenes. Optionally, the range camera is an active illumination range camera that illuminates FOV 73 with optionally IR light to acquire the range images. The facial recognition system comprises software having data and/or executable instructions, optionally stored in memory 88, that processor 84 may use to process range and/or contrast images acquired by screen camera 72 to determine presence and spatial location of the user's face in FOV 73. In an embodiment attitude controller 86 receives the spatial location of the user's face and controls attitude of display screen 61 responsive to the location to orient the display screen substantially facing the user for convenient viewing of images acquired and transmitted by targeting camera 41.

Target imaging system 40 and display system 60 may comprise any electronic and/or optical processing and/or control circuitry, to provide and enable functionalities that the systems provide. By way of example, processors 46 and/or 84 may comprise any one, or any combination of more than one of, a microprocessor, an application specific circuit (ASIC), field programmable array (FPGA) and/or system on a chip (SOC). Memories 45 and 88 may any electronic and/or optical circuitry suitable for storing data and/or computer executable instructions and may, by way of example, comprise any one or any combination of more than one of a flash memory, random access memory (RAM), read only memory (ROM), and/or erasable programmable read-only memory (EPROM).

FIGS. 1B and 1C schematically show assault rifle 30 tilted upwards and downwards relative to the horizontal orientation of the assault rifle shown in FIG. 1A and display screen 61 rotated about axis 70 (FIG. 1A, 2A-2C) accordingly by attitude controller 86 (FIG. 1A) to face gaze direction 92 of user 90. FIG. 2A schematically shows a top view of assault rifle 30 and gaze direction 92 of user 90 shown in FIG. 1A. FIGS. 2B and 2C schematically show assault rifle 30 rotated to the right and to the left relative to the orientation of the assault rifle shown in FIG. 2B and display screen 61 rotated by attitude controller 86 (FIG. 1A) about axis 70 (clearly shown in FIGS. 1A-1C) to face gaze direction 92 of user 90.

FIG. 3 schematically shows the Corner-Safe 20 shown in FIGS. 1A-2C being used by a combatant (not shown) to sight assault rifle 30 to a target 150 in an upper floor window 152 of a building 154. The combatant is positioned on a first side of a protecting wall 160 and holding the barrel of rifle 30 on a second, far side of the wall, on which far side upper story window 152 is located. A part of assault rifle 30 on the far side of the wall which is not normally seen form the perspective of FIG. 3 is shown in dashed lines. The combatant does not have a direct line of sight to target 150. However, targeting camera 41 of target imaging system 40 acquires a targeting image of building 154 upper floor window 152 and target 150 and transmits the targeting image encoded in an image transmission 50 for processing by processor 84 (FIG. 1A) and display by display system 60 on display screen 61 in accordance with an embodiment of the disclosure. Screen camera 72 acquires an image of the combatant's face and processor 84 and attitude controller 86 (FIG. 1A) cooperate to process the facial image acquired by screen camera 72 and rotate display screen 61 to display the targeting image received in image transmission 50 at an advantageous orientation for viewing by the combatant. A gaze direction of the combatant when viewing display screen 61 is schematically represented by a block arrow 92.

In an embodiment target imaging system 40 adds a fiducial marking to targeting images of a scene that targeting camera 41 acquires. The fiducial may be located at a principal point of an acquired targeting image or at a point in the targeting image that image a region of the scene acquired by targeting camera 41 to which the barrel of assault rifle 30 points. A user of the assault rifle may aim the rifle to a desired target by pointing the rifle in a direction that substantially brings the fiducial in coincidence with the desired target. By way of example, an inset 104 in FIG. 3 shows a targeting image acquired and displayed by Corner-Safe 20 on display screen 61. The targeting image shows images 152* and target 150* of window 152 and target 150 respectively and a fiducial 180, in accordance with an embodiment. In the inset fiducial 180 is below target image 150* and indicates that the combatant should lower assault rifle 30 to aim at target 150.

FIG. 4 schematically shows a piezoelectric transmission system 200 that may be used to control orientation of display screen 61 of a Corner-Safe, such as Corner-Safe 20, in accordance with an embodiment of the disclosure. Display screen 61 is optionally mounted to support frame 62 by two rotation pins 202 and the support frame seats on Lazy-Suzan coupling 64, in accordance with an embodiment of the disclosure. Lazy Suzan 64 comprises a swivel plate 64-1 rotatably connected to a base 64-2 configured to be mounted on a weapon such as assault rifle 30. Piezoelectric transmission system 200 optionally comprises a piezoelectric motor 210 friction coupled by a friction nub 211 to swivel plate 64-1. Each rotation pin 202 is coupled to a piezoelectric motor 220 friction coupled by a friction nub 221 to the rotation pin. Piezoelectric motor 210 is controllable to generate vibratory motion of friction nub 211 selectively in either direction indicated by block double arrow 212 and thereby rotate swivel plate 64-1 selectively in either corresponding direction indicated by curved block double arrow 213. Each piezoelectric motor 220 is controllable to generate vibratory motion of its friction nub 221 selectively in either direction indicated by block double arrow 222 and thereby rotate the rotation pin 202 selectively in either corresponding direction indicated by curved block double arrow 223.

FIG. 5 schematically shows a piezoelectric transmission system 300 that may be used to control orientation of a display screen 61 of a Corner-Safe, such as Corner-Safe 20, in accordance with an embodiment of the disclosure. Transmission system 300 optionally comprises a ball and socket joint comprising a rotation sphere 301a rotatably held in a socket 301b of a support base 302 configured to be mounted to a weapon. Rotation sphere is coupled by a stem 303 to display screen 61. Piezoelectric motors 311 and 312 are friction coupled to rotation sphere 300 by friction nubs 313 and 314 respectively. Piezoelectric motor 311 is controllable to generate vibrations selectively in either direction indicated by block double arrow 320 and cause rotation sphere and thereby display screen 61 to rotate selectively in corresponding clockwise or counterclockwise directions about axis 70. Piezoelectric motor 312 is controllable to generate vibrations selectively in either direction indicated by block double arrow 330 and cause rotation sphere and thereby display screen 61 to rotate selectively in corresponding clockwise or counterclockwise directions about axis 66.

It is noted that the friction coupling of piezoelectric motors in piezoelectric transmission systems may be configured to enable orienting display screen 61 by hand.

Whereas in the above description a Corner-Safe in accordance with an embodiment of the disclosure comprises a display system 60 mounted to a weapon that is to be used with Corner-Safe, practice of embodiments of the disclosure is not limited to embodiments comprising weapon mounted display systems. For example, targeting image images may be displayed on a heads up display or by augmented reality (AR) glasses worn by a user of assault rifle 30. FIG. 6 schematically illustrates assault rifle 30 coupled to a Corner-Safe 400 comprising a target imaging system 40 and a mobile phone 160 comprising software having executable instructions and/or data that supports functioning of the mobile phone as a display system of Corner-Safe 380. Target imaging system 40 transmits imaging transmissions 50 encoded with targeting images acquired by targeting camera 41 to the mobile phone for display to a user of assault rifle 30 in accordance with an embodiment. As shown in FIG. 6 mobile phone 160 may be mounted to a forearm of the user.

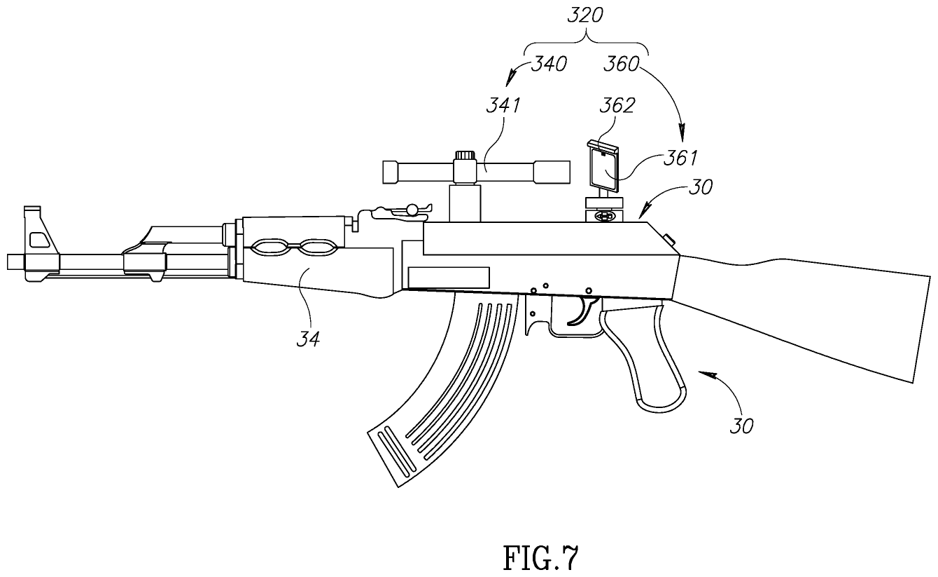

FIG. 7 schematically shows a Corner-Safe 320 mounted to an assault rifle 30, in accordance with an embodiment of the disclosure. Corner-Safe 320 comprises a target imaging system 340 having a telescopic sight 341 that images a scene to generate an enlarged virtual targeting image of the scene and a display system 360 comprising a mirror 361 that reflects light from the telescopic image to display the virtual targeting image to a user of the assault rifle. In an embodiment, mirror 361 is mounted to a support frame and Lazy-Suzan coupling similar to the manner in which display screen 61 is mounted support frame 62 and Lazy-Suzan 64 (FIG. 4). Optionally, the support frame comprises a camera 362 also referred to as a mirror camera, that acquires images of a scene along a normal to the mirror. Orientation of mirror 361 may be controlled to face the user responsive to images acquired by mirror camera 362 similarly to the way in which display screen 61 is oriented responsive to images acquired by screen camera 72.

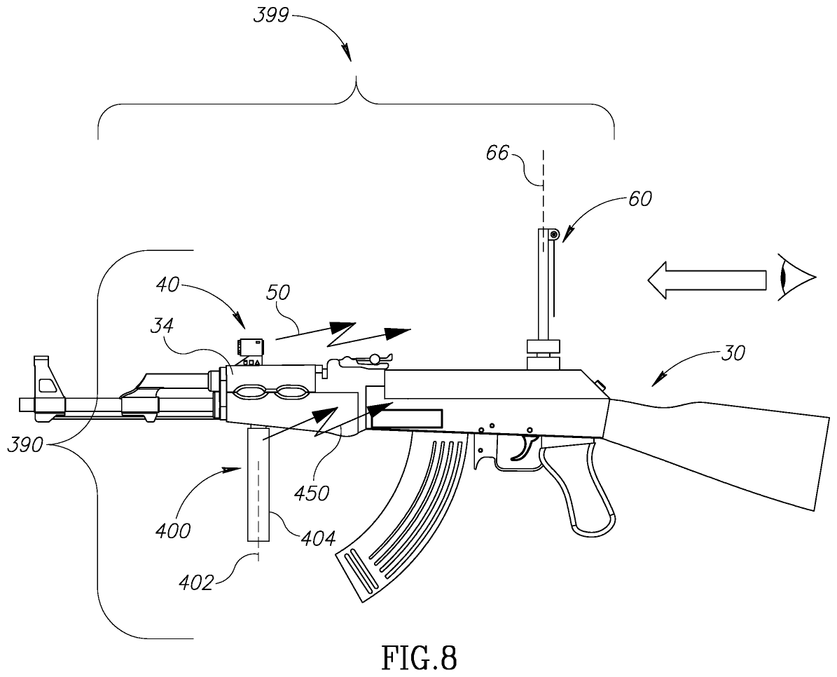

FIG. 8 schematically shows a Corner-Safe 390 comprising a display control handle 400 mounted on a handguard 34 of an assault rifle 30, in accordance with an embodiment of the disclosure. Display control handle 400 may be rotatably coupled to handguard so that the handle can be manually rotated about an axis 401 of the handle to rotate display screen 61 of display system 60 about a parallel axis 66 to a direction convenient for user viewing. In an embodiment display control handle 400 is configured to transmit its angular position about axis 402 to display system 60 via a mechanical coupling, by wire and/or wirelessly, and display system 60 is configured responsive to the angular position to substantially synchronously rotate display screen 61 to a corresponding angular position about axis 66. Wire and/or wireless transmission is schematically indicated by lightening arrow 450. Optionally, control handle 400 comprises a control button 404 operable to lock and unlock rotatability of control handle 400 about axis 402.

In an embodiment control handle 400 is mounted to handguard 34 by a ball and socket joint (not shown) that allows the control handle to be rotated about a center of a ball of the ball and socket joint. Angular position of the control handle about the center of the ball is transmitted by wire or wirelessly to display system 60 so that the display system may substantially synchronously rotate display screen 61 to a corresponding angular position about a suitable center of rotation, for example a center of ball 301 a shown in FIG. 5. Control button 404 may be operated to lock or unlock rotatability of control handle 400 about the center of the ball.

Optionally, control handle 400 is configured to have a selection of preset rotational angular positions of the control handle that correspond to preset angles of rotation of display screen 61. By way of example, preset angles of rotation of display 61 may comprise clockwise or counterclockwise angles of rotation of the display about axis 66 (FIG. 1A) equal to about 30°, 45°, 90°, and/or 120°, relative to boresighted optical axis 42 designated as 0°. Corner-Safe 390 may be configured to provide an audio or visual signal to a user when handle 400 reaches a preset rotation angle of display 61.

In an embodiment a control handle that operates similarly to control handle 400 may be configured as a rifle bipod.

In an embodiment of the disclosure a component of a Corner-Safe system, such as target imaging system 40, display system 60, and/or control handle 400 is mounted to assault rifle 30 by any of various quick release snap-fit couplings to enable the component to be quickly and easily mounted to and demounted from assault rifle 30. In an embodiment a Corner-Safe system may comprise a source of power, such as a battery and/or solar panel, to enable operation of Corner-Safe. Optionally, the source of power comprises a manually operated crank or squeeze, electrical generator, which may be incorporated in control handle 400. Optionally the electrical generator is a cylindrical electrical generator.

Whereas in the above description a Corner-Safe was described as being mounted to an assault rifle, practice of an embodiment of the disclosure is not limited to use with an assault rifle. A Corner-Safe system may be used for assistance in aiming other military equipment and/or non-military, civilian devices. For example, a Corner-Safe system may be used to assist in aiming any imaging device mounted to an extension arm used to position the imaging device in hard to access locations.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to users of the art. The scope of the invention is limited only by the claims.

1. A system for aiming a weapon, the system comprising:
an imaging system configured to be mounted to a weapon and acquire targeting images of scenes along directions in which the weapon points; and
a display system operable to display the acquired targeting images in directions suitable for convenient viewing by a user.

2. The system according to claim 1 wherein the imaging system comprises at least one camera operable to acquire the targeting images.

3. The system according to claim 2 wherein the imaging system comprises circuitry operable to transmit wireless and/or wire transmissions encoded with a targeting image that the camera acquires.

4. The system according to claim 3 wherein the display system comprises a display screen and is configured to receive the transmissions and display on the display screen the targeting images that the transmissions encode.

5. The system according to claim 4 wherein the display system comprises a transmission system operable to orient the display screen so that the display screen faces a direction convenient for viewing by the user.

6. The system according to claim 5 wherein the display screen is mounted to a support frame so that the display screen is rotatable about a first axis fixed relative to the support frame.

7. The system according to claim 6 wherein the transmission system comprises a first shaft having a first shaft axis coincident with the first axis and coupled to a piezoelectric motor operable to rotate the first shaft and display screen about the first axis.

8. The system according to claim 7 wherein the support frame is coupled to a support base so that the support frame is rotatable relative to the support base about a second axis perpendicular to the first axis.

9. The system according to claim 6 wherein the transmission system comprises a second shaft having a second shaft axis coincident with the second axis and coupled to a piezoelectric motor operable to rotate the second shaft and display screen about the second axis.

10. The system according to claim 6 wherein the support frame is coupled to a ball and socket joint so that the support frame and display screen are rotatable about the center of the ball.

11. The system according to claim 10 wherein the transmission system comprises at least one piezoelectric motor operable to rotate the ball and therefore the support frame and display screen about the center of the ball.

12. The system according to claim 5 wherein the display system comprises at least one screen camera having a field of view (FOV) and operable to acquire images in directions along which the display screen faces.

13. The system according to claim 12 wherein the display system comprises image processing circuitry operable to process images acquired by the at least one screen camera to determine if the images image the user's face and if so a location of the user's face in the screen camera FOV.

14. The system according to claim 13 wherein the display system comprises circuitry operable to control the transmission system to orient the display screen in the direction convenient for viewing by the user responsive to the location of the user's face.

15. The system according to claim 1 wherein the imaging system comprises a telescopic sight operable to acquire the targeting images and generate corresponding virtual targeting images.

16. The system according to claim 15 wherein the display system comprises a mirror operable to reflect light from the virtual targeting images to display the virtual targeting images to the user in directions suitable for convenient viewing.

17. The system according to claim 1 and comprising a human machine interface manually operable to control direction in which the display system displays the acquired targeting images.

18. The system according to claim 17 wherein the human machine interface comprises a control handle configured to be mounted to the weapon and manually rotatable to control the display system.

19. The system according to claim 18 and comprising a control button operable to lock and unlock rotatability of control handle.

20. The system according to claim 1 and comprising a human machine interface manually operable to control a gyroscope, which controls the direction in which the display system displays the acquired targeting images.
